(19) United States
(12) Patent Application Publication
(10) Pub. No.: US 2006/0272643 A1
(43) Pub. Date: Dec. 7, 2006

(54) METHODS AND RELATED SYSTEMS TO SELECTIVELY CONTROL OPERATIONAL MODES OF POSITIVE AIRWAY PRESSURE SYSTEMS

(75) Inventors: Alonzo C. Aylsworth, Wildwood, MO (US); Lawrence C. Spector, Austin, TX (US)

Correspondence Address: CONLEY ROSE, P.C., P. O. BOX 3267, HOUSTON, TX, 77253-3267, US

(73) Assignee: ACOBA, LLC, CHESTERFIELD, MO (US)

(21) Appl. No.: 11/421,521

(22) Filed: Jun. 1, 2006

Related U.S. Application Data
(60) Provisional application No. 60/688,264, filed on Jun. 7, 2005.

(51) Int. Cl. F16K 31/02

(52) U.S. Cl. 128/204.23

(57) ABSTRACT

A method and related systems to selective control operational modes of positive airway pressure systems. At least some of the illustrative embodiments are a method comprising inserting a memory card into a card reader of a positive airway pressure device, and selectively operating the positive airway pressure device in at least one of a first pressure control mode where pressure applied is substantially continuous across a patient's respiratory cycle, or a second pressure control mode where the pressure applied is reduced during exhalation of the patient (the operating based on information stored on the memory card).

### CROSS-REFERENCE TO RELATED APPLICATIONS

This application claims the benefit of provisional application Ser. No. 60/688,264, filed Jun. 7, 2005, titled “methods and related systems to selective control operational modes of positive airway pressure systems,” which application is incorporated by reference herein as if reproduced in full below.

### BACKGROUND

Sleep disordered breathing is common throughout the population, and some sleep disorder breathing may be attributable to disorders of the respiratory tract. For example, sleep apnea is a situation where a person temporarily stops breathing during sleep. A hypopnea is a period of time where a person's breathing becomes abnormally slow or shallow. In some cases, a hypopnea may precede an apnea event.

Although hypopneas and apneas may have multiple causes, one trigger for these type events may be full or partial blockages in the respiratory tract. In particular, in some patients the larynx may collapse due to forces of gravity and/or due to forces associated with lower pressure in the upper airway than outside the body. A collapse of the pharynx, larynx, upper airway or other soft tissue in the respiratory tract may thus cause the full or partial blockage, which may lead to a hypopnea or apnea event.

One method to counter collapse of the larynx is the application of positive airway pressure to the nostrils, possibly by using a CPAP machine. Using a positive airway pressure device, such as CPAP, the pressure within the pharynx, larynx, or upper airway may be greater than the pressure outside the body, thus pneumatically splinting open the airway. However, patients respond differently to different pressure control philosophies, thus limiting the marketability of a positive airway pressure device implementing a single pressure control philosophy.

### SUMMARY

The problems noted above are solved in large part by a method and related systems to selective control operational modes of positive airway pressure systems. At least some of the illustrative embodiments are a method comprising inserting a memory card into a card reader of a positive airway pressure device, and selectively operating the positive airway pressure device in at least one of a first pressure control mode where pressure applied is substantially continuous across a patient's respiratory cycle, or a second pressure control mode where the pressure applied is reduced during exhalation of the patient (the operating based on information stored on the memory card).

Other illustrative embodiments are systems comprising a first blower configured to fluidly couple to a first naris of a patient, a processor coupled to the first blower and configured to control the speed of the first blower, and a card reader electrically coupled to the processor, wherein the card reader is configured to read information from a memory device insertable into the card reader The processor, based on the information, operates the first blower in at least one of a first pressure control mode where pressure applied to the first naris of the patient is substantially continuous across a patient's respiratory cycle, or a second pressure control mode where the pressure applied is reduced during exhalation of the patient.

Other illustrative embodiments are a computer readable medium storing a program that, when executed by a processor, performs a method comprising reading (by a positive airway pressure device) information from a removable memory device, and implementing at least one of a first pressure control mode where pressure applied to the second naris of the patient by the positive airway pressure device is substantially continuous across a patient's respiratory cycle, or a second pressure control mode where the pressure applied by the positive airway pressure device is reduced during exhalation of the patient.

The disclosed devices and methods comprise a combination of features and advantages which enable it to overcome the deficiencies of the prior art devices. The various characteristics described above, as well as other features, will be readily apparent to those skilled in the art upon reading the following detailed description, and by referring to the accompanying drawings.

### BRIEF DESCRIPTION OF THE DRAWINGS

For a detailed description of the various embodiments of the invention, reference will now be made to the accompanying drawings in which:

FIG. 1 shows a system for providing positive airway pressure to a patient in accordance with at least some embodiments of the invention;

FIG. 2 shows a control system which maybe used to control a positive airway pressure device in accordance with at least some embodiments of the invention; and

FIG. 3 shows two sets of waveforms to illustrate at least some pressure control modes implemented in accordance with embodiments of the invention.

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

Further, use of the terms “pressure,” “applying a pressure,” and the like shall be in reference herein, and in the claims, to gauge pressure rather than absolute pressure. Thus, applying a negative pressure shall mean applying a pressure less than atmospheric pressure.

### DETAILED DESCRIPTION OF THE PREFERRED EMBODIMENTS

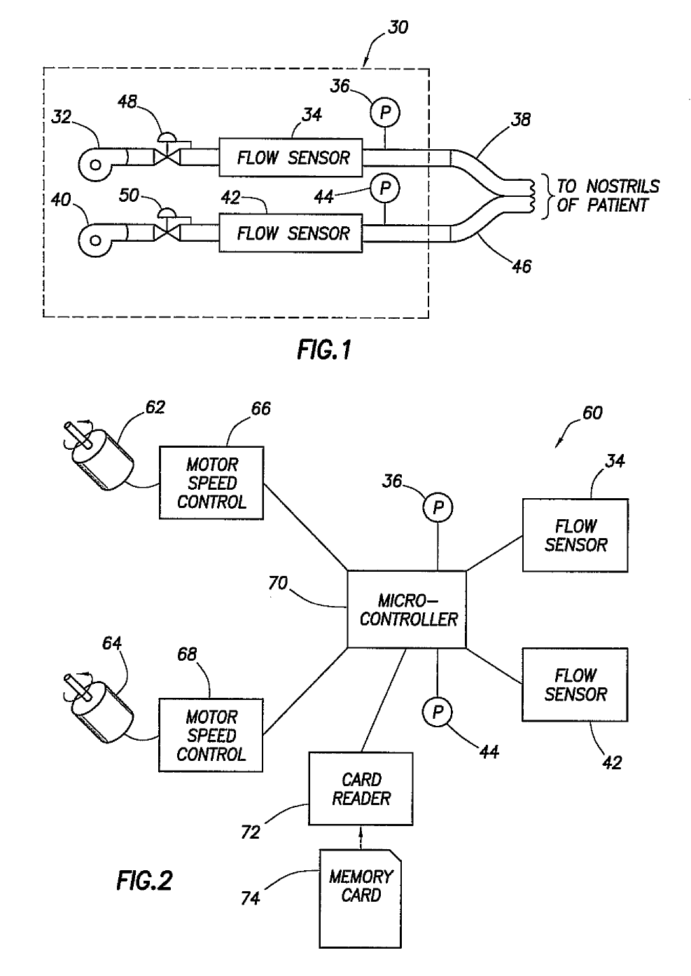

FIG. 1 illustrates a device 30 for providing positive airway pressure to a patient in accordance with some embodiments of the invention. A device 30 constructed in accordance with embodiments of the invention has the capability of individually controlling pressure and/or therapeutic gas flow to each nostril or naris of the patient. Thus, a first flow path comprises a blower 32 fluidly coupled to a flow sensor 34 and pressure transducer 36. Blower 32 may be any suitable device, such as a vane-type blower coupled to an electric motor. In alternative embodiments, a source of therapeutic gas, e.g. oxygen, may be used in addition to or in combination with the blower 32. Therapeutic gas pressure and flow created by the blower 32 may thus flow through the flow sensor 34 (of any suitable type) and to a first naris of a patient possibly through tube 38. A positive airway pressure device 30 in accordance with embodiments of the invention also comprises a second blower 40 coupled to a second flow sensor 42 and second pressure transducer 44. The blower 40 may be of similar design and construction to that of blower 32. In alternative embodiments, the blower 40 may be used in combination with or replaced by a source of compressed therapeutic gas, e.g. oxygen. Therapeutic gas pressure and flow created by blower 40 may thus flow through the flow sensor 42 (of any suitable type) and to a second naris of the patient, possibly through tube 46.

In accordance with some embodiments of the invention, the positive airway pressure device 30 controls pressure and/or flow to each naris of a patient individually. In some embodiments, therapeutic gas flow to the patient may be divided among the nares so as not to force any one naris to carry all the therapeutic gas flow. In order to ensure that each naris is carrying at least part of the therapeutic gas flow, the flow path for each naris may need individual pressure and/or flow control. Control of the pressure, and therefore the therapeutic gas flow, may take many forms. In some embodiments, the pressure may be controlled by selectively controlling blower speed, e.g. by controlling the speed of the motor coupled to the blower. In alternative embodiments, the blowers 32, 40 may be operated at a constant speed and the pressure provided to the patient may be controlled by pressure control valves 48, 50 for the blowers 32, 40 respectively. In yet other embodiments, a combination of controlling the blower speed in a pressure control valve may be utilized.

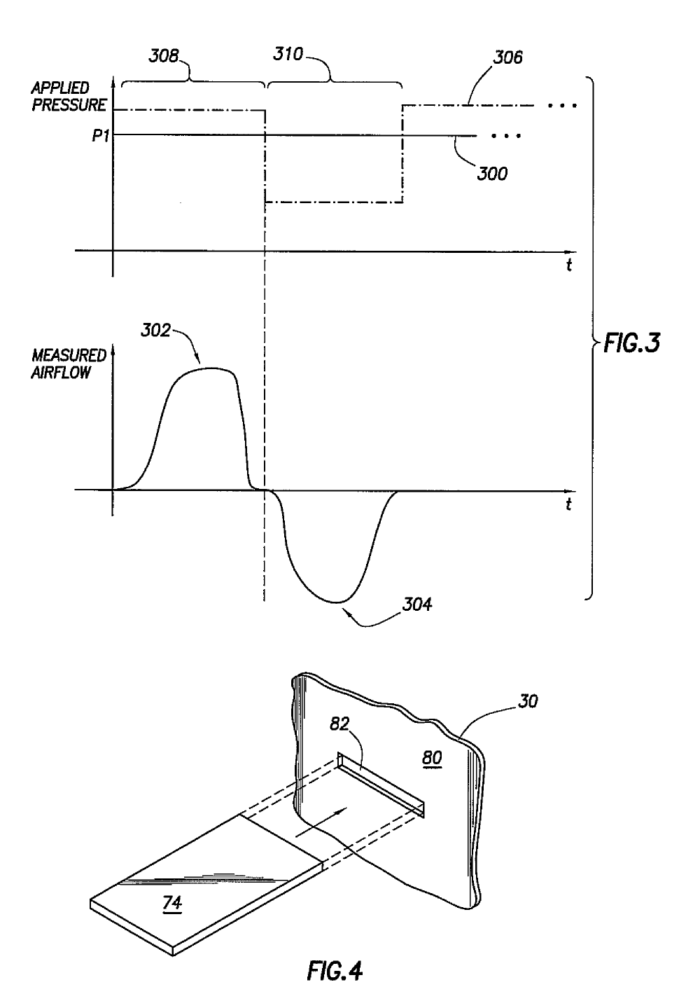

FIG. 2 illustrates a control system 60 which may be used to control the positive airway pressure device as illustrated in FIG. 2. In particular, motors 62, 64 couple one each to blower 32, 40 (not shown in FIG. 2) respectively. The speed of the output shaft of each motor 62, 64 (and therefore the blower speed) is controlled by a motor speed control unit 66, 68 respectively. In at least some embodiments, the motors 62, 64 may be DC motors, whose speed is controlled by varying the applied DC voltages. In alternative embodiments, voltage to each of the motors 62, 64 may remain constant, but may be modulated, such as by pulse width modulation control. In yet other embodiments of the invention, the motors 62, 64 may be AC motors, and in these embodiments the motor speed control circuits 66, 68 may provide control voltages having varying voltages and frequencies to the motors so as to control motor speed.

The control system 60 also comprises a microcontroller 70 coupled to the motor speed control circuits 66, 68. The microcontroller 70 may be any suitable microcontroller or microprocessor having its own read only memory 71 storing programs executable by the microcontroller 70, or possibly external read only memory. The microcontroller 70, executed programs, provides an indication to each of the motor speed control circuits 66, 68 of a desired motor speed. Although microprocessor control is preferred, the positive airway pressure device may be equivalently implemented with individual processor, memory, and input/output modules, or by way of an analog control system. Setting motor speed for a flow circuit to a naris may be based, in some embodiments, on pressures read by the microcontroller 70 from the pressure transducers 36 and 44. In other embodiments, setting motor speed for a flow circuit to a naris may be based on gas flows measured by the flow sensors 34 and 42.

In accordance with embodiments of the invention, the microcontroller 70 is provided with a doctor prescribed titration pressure. In some embodiments, the doctor prescribed titration pressure is provided by way of a dial-type input or other form of user interface. In other embodiments, the doctor prescribed titration pressure is provided by way of a secure digital interface memory card 74, such as a SDSDB or SDSDJ card produced by SanDisk of Sunnyvale Calif. When using memory such as a secure digital interface memory card 74 as the mechanism to provide the doctor prescribed titration pressure to the control system 60, a card reader 72 may be used, such as a card reader part number 547940978 manufactured by Molex Incorporated. As will be discussed more fully below, the card reader 72 and memory card 74 may also be used to provide operational information to the control system.

Based on the prescribed titration pressure, the microcontroller ramps the speed control signal passed to each of the motor speed control circuits 66 and 68 to achieve the prescribed titration pressure, at least during the inhalation of the patient. If a naris is severely congested or otherwise blocked, however, therapeutic gas flow may move only through an open naris at the prescribed titration pressure. Moreover, throughout the night, the restriction or resistance to airflow experienced within each naris may change (e.g. as a function of congestion experienced within each naris, as a function of an amount of swelling of the soft tissue within each naris, or as a function of nasal cycle (which may be caused by brain triggered muscle contractions)). Thus, even at the prescribed titration pressure applied to each naris the patient may receive inadequate therapeutic gas. Co-pending and commonly owned application Ser. No. 11/156,432, titled “Method and related system to control applied pressure in CPAP systems,” filed Jun. 20, 2005 and incorporated by reference herein as if reproduced in full below, describes methods and systems to control applied pressure to address nasal cycle effects in delivery of therapeutic gas.

In accordance with embodiments of the invention, the positive airway pressure device 30 selectively applies differing pressure control strategies. FIG. 3 illustrates at least two modes of operation in relation to a patient respiration. The applied pressure graph of FIG. 3 shares a time axis with the measured airflow graph to illustrate the relationship. In particular, the applied pressure graph of FIG. 3 illustrates application of a continuous pressure (by line 300) in relation to the inhalation portion 302 of a patient respiration and the exhalation portion 304 of the patient respiration. In this mode of operation, the device 30 (FIG. 1) operates as a continuous positive airway pressure device.

FIG. 3 also illustrates a second mode of operation (by dash-dot line 306). In this second mode of operation, the pressure applied by the device 30 is a function of the whether the patient's respiration is in the inhalation portion or exhalation portion. In particular, while the patient's respiration is in the inhalation portion 302, the device 30 applies a first pressure (illustrated by region 308). When the patient's respiration is in the exhalation portion 304, the device 30 applies a second, lower pressure (illustrated by region 310). Thus, the pressure applied is reduced during exhalation, possibly to reduce the amount of effort required by the patient to exhale, or if applied on a single naris to ensure approximately the same narial airflow during exhalation. Application of differing pressures in this manner may be referred to as bi-level pressure application. In some embodiments, the pressure applied during exhalation may be negative (less than atmospheric), and thus assist the patient in exhalation.

Although FIG. 3 shows the pressure applied in the bi-level mode to be higher than in the continuous mode, this need not necessarily be the case. Further, the mode of operation may be the same as between the nares, or differing modes of operation may be used with respect to each naris. In other embodiments, selectively using differing modes of operation may be used in a device 30 that applies pressure to both nares simultaneously (single plenum coupled to the nares).

Referring again to FIG. 2, in accordance with some embodiments of the invention, which of the illustrative pressure control modes to utilize (or in what combination) may be communicated to the control system 60 of device 30 (FIG. 1) by way of memory card 74 and card reader 72. In particular, the microcontroller 70 may read information off the memory card 74, and the information defines the operational mode. Thus, in some embodiments data in the form of the patient's prescription set point and pressure control mode may be read from the memory card 74 by way of the card reader 72. Based on that data, the microcontroller may thus implement the control mode. In alternative embodiments, the memory card 74 holds a program that is executed by the microcontroller 70, and executing the program may thus implement the desired pressure control modes. Thus, device 30 may be selectively operated in a continuous positive airway pressure and/or a bi-level mode, thus negating the need for the patient to purchase a second device if the pressure control strategy for the patient should change.

In accordance with at least some embodiments, the memory card 74 is inserted into the card reader 72 through an aperture in a cover of the positive airway pressure device. In particular, FIG. 4 illustrates a portion of an outer cover 80 of a positive airway pressure device 30. The outer cover 80 has therein an aperture 82. In accordance with some embodiments of the invention, the memory card 74 is inserted into the card reader 72 (not visible in FIG. 4) through the aperture 82. Thus, in these embodiments the positive airway pressure device 30 may receive the patient's titration pressure and/or information regarding the mode the positive airway pressure device should operate. As mentioned above, the information on the memory card 74 may be data that triggers an operational mode whose software already resides within the positive airway pressure device, or in alternative embodiments the software instructions to implement a particular operation mode may be stored on memory card itself Thus, the positive airway pressure device may be provided information that changes operational modes without having to disassemble the positive airway pressure device, such as to replace programmable read only memories storing programs executed by the microcontroller 70.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method comprising:
inserting a memory card into a card reader of a positive airway pressure device; and
selectively operating the positive airway pressure device in at least one of a first pressure control mode where pressure applied is substantially continuous across a patient's respiratory cycle, or a second pressure control mode where the pressure applied is reduced during exhalation of the patient, the operating based on information stored on the memory card.

2. The method as defined in claim 1 wherein selectively operating farther comprises applying a selected pressure control mode to the nares as a group.

3. The method as defined in claim 1 wherein selectively operating farther comprises applying a selected pressure control mode individually to each naris.

4. The method as defined in claim 1 wherein selectively operating further comprises applying the first pressure control mode to a first naris and the second pressure control mode to a second naris.

5. The method as defined in claim 1 wherein inserting further comprises inserting through an aperture in an outer cover of the positive airway pressure device.

6. A system comprising:
a first blower configured to fluidly couple to a first naris of a patient;
a processor coupled to the first blower and configured to control the speed of the first blower; and
a card reader electrically coupled to the processor, wherein the card reader is configured to read information from a memory device insertable into the card reader;
wherein the processor, based on the information, operates the first blower in at least one of a first pressure control mode where pressure applied to the first naris of the patient is substantially continuous across a patient's respiratory cycle, or a second pressure control mode where the pressure applied is reduced during exhalation of the patient.

7. The system as defined in claim 6 wherein the information readable by the card reader is data that defines use of at least one of the first or second pressure control modes.

8. The system as defined in claim 6 wherein the information readable by the card reader is a program executable by the processor, and wherein the program implements at least one of the first or second pressure control modes.

9. The system as defined in claim 6 further comprising:
a second blower configured to couple to a second naris of the patient, and electrically coupled to the processor;
wherein the processor, based on the information, operates the second blower in at least one of a first pressure control mode where pressure applied to the second naris of the patient is substantially continuous across a patient's respiratory cycle, or a second pressure control mode where the pressure applied is reduced during exhalation of the patient.

10. The system as defined in claim 9 wherein the processor operates the first and second blower in the same control mode.

11. The system as defined in claim 9 wherein the processor operates the first and second blower in different control modes.

12. The system as defined in claim 6 wherein the memory device is inserted into the card reader through an aperture in an outer cover in the system.

13. A system comprising:
a first means for generating pressure and flow, the first means for generating configured to fluidly couple to a first naris of a patient;
a means for executing programs, the means for executing configured to control the speed of the first means for generating; and
a means for reading a nonvolatile memory electrically coupled to the means for executing, wherein the means for reading is configured to read information from a memory means insertable into the means for reading;
wherein the means for executing, based on the information, operates the first means for generating in at least one of a first pressure control mode where pressure applied to the first naris of the patient is substantially continuous across a patient's respiratory cycle, or a second pressure control mode where the pressure applied is reduced during exhalation of the patient.

14. The system as defined in claim 13 wherein the information readable by the means for reading is data that defines use of at least one of the first or second pressure control modes.

15. The system as defined in claim 13 wherein the information readable by the means for reading is a program executable by the means for executing, and wherein the program implements at least one of the first or second pressure control modes.

16. A computer readable medium storing a program that, when executed by a processor, performs a method comprising:
reading, by a positive airway pressure device, information from a removable memory device; and
implementing at least one of a first pressure control mode where pressure applied to the second naris of the patient by the positive airway pressure device is substantially continuous across a patient's respiratory cycle, or a second pressure control mode where the pressure applied by the positive airway pressure device is reduced during exhalation of the patient.

17. The computer readable medium as defined in claim 16 wherein reading further comprises reading data that is indicative of which of the first and/or second pressure control mode with which to operate.

18. The computer readable medium as defined in claim 16 wherein reading further comprises reading a program from the removable memory device, and executing the program which then implements the at least one of the first and second pressure control modes.
